(19) United States
(12) Patent Application Publication
(10) Pub. No.: US 2023/0040914 A1
(43) Pub. Date: Feb. 9, 2023

(54) LEARNING DEVICE, LEARNING METHOD, AND LEARNING PROGRAM

(71) Applicant: NEC Corporation, Minato-ku, Tokyo (JP)

(72) Inventor: Riki Eto, Tokyo (JP)

(73) Assignee: NEC Corporation, Minato-ku, Tokyo (JP)

(21) Appl. No.: 17/783,070

(22) PCT Filed: Dec. 25, 2019
(86) PCT No.: PCT/JP2019/050881

§ 371 Date: Jun. 7, 2022

(51) Int. Cl. G06N 5/04

(52) U.S. Cl. CPC G06N 5/043

(57) ABSTRACT

An input unit 81 receives input of a decision-making history of a subject. A learning unit 82 learns hierarchical mixtures of experts by inverse reinforcement learning based on the decision-making history. An output unit 83 outputs the learned hierarchical mixtures of experts. The learning unit 82 learns the hierarchical mixtures of experts using an EM algorithm, and when a learning result using the EM algorithm satisfies a predetermined condition, learns the hierarchical mixtures of experts by factorized asymptotic Bayesian inference.

### TECHNICAL FIELD

The present invention relates to a learning device, a learning method, and a learning program for learning hierarchical mixtures of experts.

### BACKGROUND ART

In recent years, the technology to automatically formulate and mechanize optimal decision making in various tasks has become more important. In general, in order to make optimal decisions, the optimization target is formulated as a mathematical optimization problem, and the optimal action is determined by solving the problem. In this case, the formulation of the mathematical optimization problem is the key, but it is difficult to formulate it manually. Therefore, attempts are being made to further develop the technology by simplifying this formulation.

Inverse reinforcement learning is known as one of the methods to formulate mathematical optimization problems. Inverse reinforcement learning is a method of learning an objective function (reward function) that evaluates the action of each state based on the history of decision making of an expert.

Note that the intention assumed by an expert is complex and vary depending on the situation. Therefore, if multiple intentions are simply modeled, the reward function also becomes complex, and it is difficult to determine the intention of an expert from the estimated reward function. Therefore, there is a need for a method to learn complex intentions as a reward function expressed in a human-interpretable form, i.e., a combination of multiple simple intentions.

With respect to learning methods in a human-interpretable form, non-patent literature 1 describes a segmented sparse linear regression model that allows selection of a prediction model for each case. The segmented sparse linear regression model described in the non-patent literature 1 is a type of Hierarchical Mixtures of Experts (HME), and is represented by a tree structure in which a component (a reward function and a prediction model) is assigned to a leaf node and a node called a gate function is assigned to other nodes.

### CITATION LIST

### Patent Literature

PTL 1: International Patent Publication No. 2017/159126

### Non-Patent Literature

NPL 1: Riki Eto, Ryohei Fujimakiy, Satoshi Morinaga, Hiroshi Tamano, “Fully-Automatic Bayesian Piecewise Sparse Linear Models”, AISTATS, pp. 238-246, 2014.

### SUMMARY OF INVENTION

### Technical Problem

The system described in the patent literature 1 does not assume the use of hierarchical mixtures of experts. In addition, the method described in the non-patent literature 1 does not describe a learning method that takes inverse reinforcement learning into account. Therefore, even if the inverse reinforcement learning described in the patent literature 1 is combined with the hierarchical mixtures of experts learning described in the non-patent literature 1, learning results with sufficient accuracy may not be obtained.

Therefore, it is an exemplary object of the present invention to provide a learning device, a learning method, and a learning program capable of improving an estimation accuracy of the model when learning hierarchical mixtures of experts by inverse reinforcement learning.

### Solution to Problem

A learning device according to the exemplary aspect of the present invention includes an input unit which receives input of a decision-making history of a subject, a learning unit which learns hierarchical mixtures of experts by inverse reinforcement learning based on the decision-making history, and an output unit which outputs the learned hierarchical mixtures of experts, wherein the learning unit learns the hierarchical mixtures of experts using an EM algorithm, and when a learning result using the EM algorithm satisfies a predetermined condition, learns the hierarchical mixtures of experts by factorized asymptotic Bayesian inference.

A learning method according to the exemplary aspect of the present invention includes receiving input of a decision-making history of a subject, learning hierarchical mixtures of experts by inverse reinforcement learning based on the decision-making history, outputting the learned hierarchical mixtures of experts, and when the learning, learning the hierarchical mixtures of experts using an EM algorithm, and when a learning result using the EM algorithm satisfies a predetermined condition, learning the hierarchical mixtures of experts by factorized asymptotic Bayesian inference.

A learning program according to the exemplary aspect of the present invention causes a computer to execute an input process of receiving input of a decision-making history of a subject, a learning process of learning hierarchical mixtures of experts by inverse reinforcement learning based on the decision-making history, and an output process of outputting the learned hierarchical mixtures of experts, wherein the learning program causes the computer to learn the hierarchical mixtures of experts using an EM algorithm, and when a learning result using the EM algorithm satisfies a predetermined condition, learn the hierarchical mixtures of experts by factorized asymptotic Bayesian inference, in the learning process.

### Advantageous Effects of Invention

According to the exemplary aspect of the present invention, it is possible to improve an estimation accuracy of the model when learning hierarchical mixtures of experts by inverse reinforcement learning.

### BRIEF DESCRIPTION OF DRAWINGS

FIG. 1 It depicts a block diagram showing a configuration example of an exemplary embodiment of a learning device according to the present invention.

FIG. 2A It depicts an explanatory diagram explaining summarized hierarchical mixtures of experts.

FIG. 2B It depicts an explanatory diagram explaining summarized hierarchical mixtures of experts.

FIG. 3 It depicts an explanatory diagram showing an example of hierarchical mixtures of experts.

FIG. 4 It depicts an explanatory diagram showing an operation example of the learning device.

FIG. 5 It depicts a block diagram showing a summarized learning device according to the present invention.

FIG. 6 It depicts a summarized block diagram showing a configuration of a computer for at least one exemplary embodiment.

### DESCRIPTION OF EMBODIMENTS

Hereinafter, an exemplary embodiment of the present invention will be described with reference to the drawings. The present invention assumes a situation where hierarchical mixtures of experts is learned by inverse reinforcement learning.

Inverse reinforcement learning is a learning method that estimates the reward function of an expert by updating the reward function so that the history of decision making is closer to that of the expert. In inverse reinforcement learning, learning is usually performed using the decision-making history of an expert, a simulator or actual machine that represents the state of a machine when it is actually operated, and a state transition (prediction) model that represents the predicted transition destination according to the state.

In more detail, first, an initial value of the reward function is set, and then a decision-making simulation using this reward function is performed. Specifically, as the decision-making simulation based on reinforcement learning, an optimization calculation is performed to determine a policy using a state transition model, a reward function, and a simulator, and a decision-making history is determined as a history of states and action output based on the policy. The optimal control may be executed as this decision-making simulation. The reward function is updated in order to reduce a difference between the decision-making history based on the reward function and the decision-making history of the expert. Then, the decision-making simulation is performed using updated reward function to determine the decision-making history, and the reward function is updated in the same manner. By repeating the above process, the reward function of the expert is estimated so that the difference between the reward function and the decision-making of the expert is eliminated.

However, it is generally difficult to refine the state transition model. Therefore, a method of model-free inverse reinforcement learning has been proposed, in which a reward function can be estimated without using the state transition model, as described in patent literature 1, for example.

On the other hand, decision-making history acquired under various situations can be said to be data including various intentions of experts. For example, the driving data of driver includes driving data of drivers with different characteristics and driving data in different situations of driving scenes. Since it would be very costly to try to classify and learn these driving data by various situations and features, it is preferable to estimate a model that allows selection of the reward function to be applied according to the conditions.

One such estimating method is a learning method that combines the model-free inverse reinforcement learning described above with hierarchical mixtures of experts learning. With this learning method, the decision-making history of an expert is divided into cases, and the learning of the reward function and branching rules for each case is alternately repeated until the decision-making history of the expert can be reproduced with high accuracy, thereby allowing the branching conditions and the reward function in each case to be estimated.

Furthermore, the factorized information criterion is known as a criterion for evaluating a so-called singular model, which makes a prediction while switching between multiple models. The factorized information criterion is a criterion that measures the quality of the model that guides the search. By finding a model that maximizes this factorized information criterion, it is possible to estimate an appropriate model.

Factorized Asymptotic Bayesian (FAB) inference is a search algorithm for finding a model that maximizes the factorized information criterion. In factorized asymptotic Bayesian inference, the factorized information criterion is maximized by repeatedly executing a process (hereinafter, referred to as a E-step) of updating the variational probability of the hidden variable and a process (hereinafter, referred to as a M-step) of updating the branching condition and reward function for the parameter and model that maximizes the factorized information criterion.

In addition, as a method of model-free inverse reinforcement learning is relative entropy inverse reinforcement learning. The relative entropy inverse reinforcement learning is a method that can learn a reward function model-free by using sampling from a decision-making history with random policies. The relative entropy inverse reinforcement learning uses importance sampling based on the random policy.

It can be assumed that learning hierarchical mixtures of experts by model-free inverse reinforcement learning can improve an estimation accuracy of the model. However, there are some points to consider when updating the factorized information criterion using an approximation by importance sampling. In factorized asymptotic Bayesian inference, it is assumed that the value of the factorized information criterion is improved in each process. However, there is a possibility that the factorized information criterion will not improve due to the effect of an approximation by importance sampling. In this case, it is not necessarily possible to improve an estimation accuracy of the model.

Therefore, it is desirable to be able to improve an estimation accuracy of the model when learning hierarchical mixtures of experts by model-free inverse reinforcement learning, which does not use a state transition model, even when an approximation by importance sampling is used. Therefore, in this exemplary embodiment, when learning hierarchical mixtures of experts by model-free inverse reinforcement learning, even when an approximation by importance sampling is used, a configuration that can improve the estimation accuracy of the model will be mainly described.

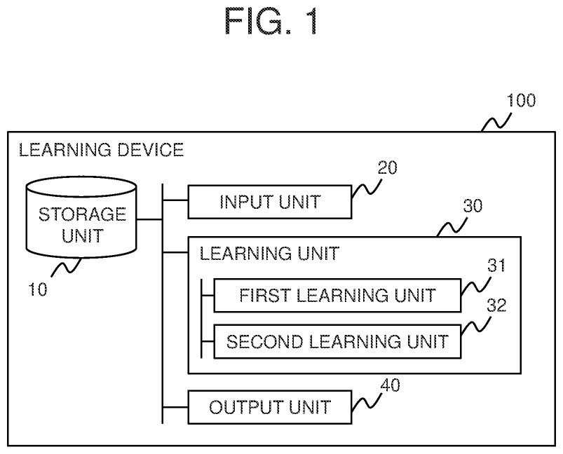

FIG. 1 is a block diagram showing a configuration example of an exemplary embodiment of a learning device according to the present invention. The learning device 100 of this exemplary embodiment comprises a storage unit 10, an input unit 20, a learning unit 30, and an output unit 40.

The learning device 100 is a device for performing inverse reinforcement learning to estimate a reward (function) from an action of a subject, and learns hierarchical mixtures of experts. An example of the subject is an expert (skilled person) in the field. One type of inverse reinforcement learning performed by the learning device 100 of this exemplary embodiment is relative entropy inverse reinforcement learning that learns a reward function without using a state transition model (i.e., model-free).

Here, the model-free inverse reinforcement learning described above will be described. In inverse reinforcement learning, a probability model of a history (history of action a for state s) based on Feature Matching is generally introduced. Now, when the decision-making history (also called trajectory) is τ=s₁a₁, . . . , s_{H}a_{H}, the reward function r(τ) can be expressed by Equation 1 below.

$$\begin{matrix}[ Math . 1 ] & \\ r ( τ ) = {\sum }_{s , a ∈ τ} r ( s , a ) = {\sum }_{s , a ∈ τ} {θ}^{τ} {f}_{s , a} = {θ}^{τ} {f}_{τ} & ( Equation 1 )\end{matrix}$$

In Equation 1, r(s,a) represents a reward obtained by the action for the state. In addition, θ is a parameter to be optimized by inverse reinforcement learning, f_{τ} is a feature of the decision-making history (i.e., feature of trajectory), and f_{s,a} is a feature for an individual decision-making.

Here, when the set of expert trajectories is D_{E}, in reverse reinforcement learning, the purpose is to find P(τ) that satisfies Equation 2 or Equation 3 below so that the following constraints representing Feature Matching is satisfied.

$${\sum }_{τ ∈ T} P ( τ ) {f}_{τ} \approx {\dot{f}}_{E} := \frac{1}{\vert {𝒟}_{E} \vert} {\sum }_{τ ∈ {𝒟}_{E}} {f}_{τ} \qquad [ Math . 2 ]$$

Specifically, in Equation 2, the purpose is to find a distribution P(τ) maximizes entropy, and in Equation 3, the purpose is to find a distribution P(τ) minimizes relative entropy. Note that Q(τ) is a baseline distribution.

$$\begin{matrix}[ Math . 3 ] & \\ P ( τ ) = {argmax}_{P} \{ - P ( τ ) log P ( τ ) \} & ( Equation 2 )\end{matrix}$$

$$P ( τ ) = {argmin}_{P} P ( τ ) log \frac{P ( τ )}{Q ( τ )} \qquad ( Equation 3 )$$

By the method of Lagrange multiplier, when 0 is an undecided multiplier, the probability distribution in maximum entropy inverse reinforcement learning using Equation 2 shown above is expressed by Equation 4 below. The probability distribution in relative entropy inverse reinforcement learning using Equation 3 shown above is expressed by Equation 5 below.

$$\begin{matrix}[ Math . 4 ] & \\ P ( τ \vert θ ) = \frac{exp ( {θ}^{T} {f}_{τ} )}{{\sum }_{τ ∈ T} exp ( {θ}^{T} {f}_{τ} )} & ( Equation 4 )\end{matrix}$$

$$P ( τ \vert θ ) = \frac{Q ( τ ) exp ( {θ}^{T} {f}_{τ} )}{{\sum }_{τ ∈ T} Q ( τ ) exp ( {θ}^{T} {f}_{τ} )} \qquad ( Equation 5 )$$

Equation 5, shown above is used to perform model-free inverse reinforcement learning. Specifically, the reward function can be learned in a model-free manner, by sampling from the decision-making history by random policy using Equation 5. Hereinafter, a method for learning the reward function without using the state transition model described above will be explained. Now, when the state transition model is D(τ) and the baseline policy is π_{b}(τ), the baseline distribution Q(τ) is represented by the product of the state transition model and the baseline policy. In other words, Q(τ)=D(τ) Rb(b). The baseline policy π_{b}(τ) and the baseline distribution Q(τ) can be defined as follows.

[Math. 5]

D(τ)=dₒ(s₁)Πₜ₌₁^{H}p(sₜ₊₁|sₜ,aₜ)

π_{b}(τ)=Πₜ₌₁^{H}π_{b}(aₜ|sₜ)

At this time, the update equation for the kth component of the weight vector θ of the reward function based on maximum likelihood estimation is expressed by Equation 6 below.

$$\begin{matrix}[ Math . 6 ] & \\ {θ}_{k} ← {θ}_{k} + α \{ \frac{1}{\vert {𝒟}_{E} \vert} {\sum }_{τ ∈ {𝒟}_{E}} {f}_{τ , k} - {\sum }_{τ ∈ T} P ( τ \vert ) {f}_{τ , k} \} & ( Equation 6 )\end{matrix}$$

In the case of performing importance sampling, when a set of trajectories sampled by the sampling policy πₛ (aₜ|sₜ) is Dₛₐₘₚ, the second term in parentheses in Equation 6 shown above can be transformed into an equation shown in Equation 7 below.

$$\begin{matrix}[ Math . 7 ] & \\ \frac{{\sum }_{τ ∈ {𝒟}_{samp}} \frac{D ( τ ) {π}_{b} ( τ )}{D ( τ ) {π}_{b} ( τ )} exp ( {θ}^{T} {f}_{τ} ) {f}_{τ , k}}{{\sum }_{τ ∈ {𝒟}_{samp}} \frac{D ( τ ) {π}_{b} ( τ )}{D ( τ ) {π}_{b} ( τ )} exp ( {θ}^{T} {f}_{τ} )} & ( Equation 7 )\end{matrix}$$

Then, assuming that both πₛ (aₜ|sₜ) and π_{b} (aₜ|sₜ) are uniform distributions, Equation 7 above can be transformed into an equation shown in Equation 8 below.

$$\begin{matrix}[ Math . 8 ] & \\ \frac{{\sum }_{τ ∈ {𝒟}_{samp}} exp ( {θ}^{T} {f}_{τ} ) {f}_{τ , k}}{{\sum }_{τ ∈ {𝒟}_{samp}} exp ( {θ}^{T} {f}_{τ} )} & ( Equation 8 )\end{matrix}$$

As a result of the above process, the weight coefficient vector θ of the reward function can be updated without using the state transition model D(T), as shown in Equations 6 and 8.

The storage unit 10 stores information necessary for the learning device 100 to perform various processes. The storage unit 10 may store various parameters used for the process by the learning unit 30 described below. The storage unit 10 may also store a decision-making history of the subject received by the input unit 20 described below. The storage unit 10 is realized by a magnetic disk or the like, for example.

The input unit 20 receives an input of the decision-making history (trajectory) of the subject. For example, when learning for the purpose of automatic driving, the input unit 20 may receive the input of a large amount of driving history data based on the complex intentions of the driver as the decision-making history. Specifically, the decision-making history is represented as time-series data {sₜ, aₜ}ₜ₌₁^{H} of combinations of the state sₜ at time t and the action aₜ at time t.

The learning unit 30 learns hierarchical mixtures of experts by inverse reinforcement learning based on the received decision-making history. In particular, the learning unit 30 of this exemplary embodiment learns hierarchical mixtures of experts using an EM (expectation-maximization) algorithm, and when a learning result using the EM algorithm satisfies a predetermined condition, learns the hierarchical mixtures of experts by factorized asymptotic Bayesian inference.

Hereinafter, as an example of a specific learning method by the learning unit 30, a method for learning hierarchical mixtures of experts by relative entropy inverse reinforcement learning using importance sampling based on random policy will be explained. As described above, relative entropy inverse reinforcement learning is a method for learning a reward function without using a state transition model (i.e., model-free) by using sampling from a decision-making history with random policies.

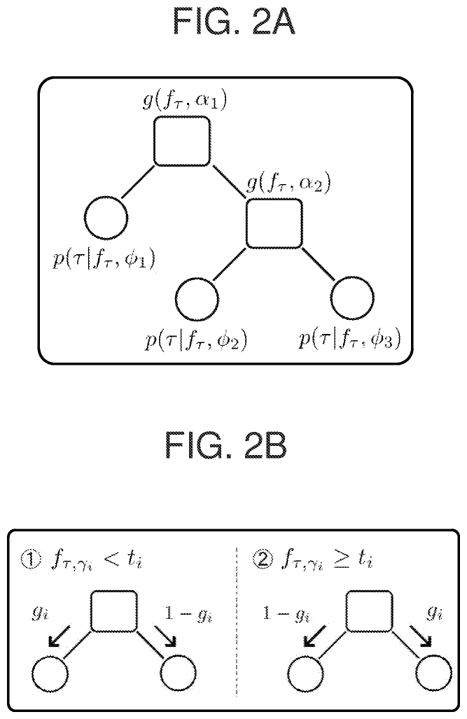

FIG. 2 is an explanatory diagram explaining summarized hierarchical mixtures of experts. The model shown in FIG. 2A is an example of hierarchical mixtures of experts, and the branching probabilities are calculated at each gate for the input data f_{τ}∈R^{D} indicating the state and the observation information, then the reward function corresponding to the leaf with the highest probability of reaching is selected according to the state and the observation information.

For example, when the Bernoulli-type gate function illustrated in FIG. 2B is used, the gate function can be defined as in Equation 9 below. In Equation 9, gᵢ∈[0, 1], U is a step function, γᵢ is an index on the dimension of f_{τ}∈R^{D}, D is the dimension of fₜ, and tᵢ ∈R represents an arbitrary value. For example, as shown in FIG. 2B, if f_{τ, γi}<tᵢ, then g(f_{τ}, αᵢ)=gᵢ and otherwise g(f_{τ}, αᵢ)=1−gᵢ.

[Math. 9]

g(fᵣ,αᵢ)=gᵢU(tᵢ−f_{τ,γi})+(1−gᵢ)U(f_{τ,γi}−tᵢ)

αᵢ={gᵢ,γᵢ,tᵢ} (Equation 9)

Using the gate function shown in Equation 9, a HME model can be expressed as the probability model shown in Equation 10 below. In Equation 10, τ∈{1, −1} represents the reward function, θ=(φ₁, . . . , φ_{E}) represents the parameter of the model, E represents the number of reward functions. Note that εⱼ (j=1, . . . , E) is an index set of the gate functions (including the highest gate function) existing on the path connecting the highest gate function and the jth reward function.

$$\begin{matrix}[ Math . 10 ] & \\ p ( τ \vert {f}_{τ} , θ ) = {\sum }_{j = 1}^{E} {\prod }_{i ∈ {ε}_{j}} {ψ}_{g} ( {f}_{τ} , i , j ) p ( τ \vert {f}_{τ} , {ϕ}_{j} ) \\ & ( Equation 10 )\end{matrix}$$

Also, ψ_{g}(f_{τ}, i, j): =ψ(g(f_{τ}, αᵢ), i, j) is the probability of the i-th gate function, and the j-th gate function is selected for f_{τ} is Πᵢ∈_{εj}ψ_{g}^{(i,j)}(f_{τ}). This corresponds to the wavy underlined part in Equation 10. Note that ψ(a, i, j) is ψ(a, i, j)=a when the j-th reward function is in the left subtree of the i-th gate function, and when it is in the right subtree, ψ(a, i, j)=1−a.

Next, the hidden variable corresponding to the j-th path (i.e., the hidden variable representing that the j-th reward function is selected) is ζⱼ. ζⱼ is defined as in Equation 11 below. The i-th node also has a binary variable zᵢ ∈{0, 1}. zᵢ=1 indicates that data is generated from the left-hand branch and zᵢ=0 indicates the opposite. At this time, the probability of zᵢ is given by Equation 12 below.

$$\begin{matrix}[ Math . 11 ] & \\ {ζ}_{j} = {\prod }_{i ∈ {ε}_{j}} ψ ( {z}_{i} , i , j ) ∈ \{ 0 , 1 \} & ( Equation 11 )\end{matrix}$$

$$p ( {z}_{i} \vert {f}_{τ} , {α}_{i} ) = {g ( {f}_{τ} , {α}_{i} )}^{{z}_{i}} {\{ 1 - g ( {f}_{τ} , {α}_{i} ) \}}^{1 - {z}_{i}} \qquad ( Equation 12 )$$

At this time, the full likelihood function of an HME model is defined as in Equation 13 below.

$$\begin{matrix}[ Math . 12 ] & \\ p ( {τ}^{N} \vert {ζ}^{N} , {f}_{τ}^{N} , ϕ ) = {{\prod }^{N}}_{n = 1} {{\prod }^{E}}_{j = 1} {p ( {τ}^{( n )} \vert {f}_{τ}^{( n )} , {ϕ}_{j} )}^{{ζ}_{j}^{( n )}} \\ p ( {ζ}^{N} \vert {f}_{τ}^{N} , α ) = {{\prod }^{N}}_{n = 1} {{\prod }^{E}}_{j = 1} {\prod }_{i ∈ {ε}_{j}} {{ψ}_{g} ( {f}_{τ}^{( n )} , i , j )}^{{ζ}_{j}^{( n )}} & ( Equation 13 )\end{matrix}$$

Here, it is possible to perform FAB inference by using an approximate value of the lower limit of a factorized information criterion. Specifically, assuming that qⱼ^{N} is a variational probability of ζⱼ^{N}, the lower limit of the factorized information criterion is expressed by Equation 14 below.

$$\begin{matrix}[ Math . 13 ] & \\ {FIC}_{LB} ( θ , q ) = {max}_{q} \{ {𝔼}_{q} [ log p ( {τ}^{N} , {ζ}^{N} \vert {f}_{τ}^{N} , θ ) ] - {\sum }_{i = 1}^{G} ( \text{?} log {\sum }_{n = 1}^{N} {\sum }_{j ∈ {𝒢}_{i}} {q}_{j}^{( n )} ) - {\sum }_{j = 1}^{E} \frac{1}{2} \text{?} log ( {l}_{jk} {\sum }_{n = 1}^{N} {q}_{j}^{( n )} ) + {H}_{q} \} \\ \text{?} \text{indicates text missing or illegible when filed} & ( Equation 14 )\end{matrix}$$

Then, the approximate value of the factorized information criterion by importance sampling is calculated using Equations 15 and 16 below.

$$\begin{matrix}[ Math . 14 ] & \\ {𝔼}_{q} [ log p ( {τ}^{N} , {ζ}^{N} \vert {f}_{τ}^{N} , θ ) ] = {\sum }_{n = 1}^{N} {\sum }_{j = 1}^{E} {q}_{j}^{( n )} \{ {ϕ}_{j}^{T} {f}_{τ}^{( n )} - log {\sum }_{τ} Q ( τ ) exp ( {ϕ}_{j}^{T} {f}_{τ}^{( n )} ) + const . & ( Equation 15 )\end{matrix}$$

$${l}_{jk} = \frac{{\sum }_{τ} Q ( τ ) exp ( {ϕ}_{j}^{T} {f}_{τ} ) {f}_{τ} {\sum }_{τ} Q ( τ ) exp ( {ϕ}_{j}^{T} {f}_{τ} ) {f}_{τ}^{T}}{{\{ {\sum }_{τ} Q ( τ ) exp ( {ϕ}_{j}^{T} {f}_{r} ) \}}^{2}} - \frac{{\sum }_{τ} Q ( τ ) exp ( {ϕ}_{j}^{T} {f}_{τ} ) {f}_{τ} {f}_{τ}^{T}}{{\sum }_{τ} Q ( τ ) exp ( {ϕ}_{j}^{T} {f}_{τ} )} \qquad ( Equation 16 )$$

Further, in the FAB inference, in the process (E-step) of updating the variational probability of the hidden variable, the expected value is calculated by Equation 17, which is illustrated below, and in the updating (M-step) of branching conditions and reward functions, the process of updating the parameters is performed by Equations 18 and 19 shown below.

$$\begin{matrix}[ Math . 15 ] & \\ {q}_{j}^{( n , t )} ∝ {\prod }_{i ∈ {ε}_{i}} {ψ}_{g}^{( t - 1 )} ( {f}_{τ}^{( n )} , i , j ) p ( {τ}^{( n )} \vert {f}_{τ}^{( n )} , {ϕ}_{j}^{( t - 1 )} ) {exp \{ {\sum }_{i ∈ {ε}_{j}} \frac{- {D}_{{α}_{i}}}{2 {\sum }_{n = 1}^{N} {\sum }_{j ∈ {𝒢}_{i}} {q}_{j}^{( n )}} + \frac{- {D}_{{ϕ}_{i}}}{2 {\sum }_{n = 1}^{N} {q}_{j}^{( n )}}}_{} & ( Equation 17 )\end{matrix}$$

$$\{ \begin{matrix}{α}_{i}^{( t )} = & \begin{matrix}{argmax}_{{α}_{i}} {\sum }_{n = 1}^{N} {\sum }_{j ∈ {𝒢}_{i}} {q}_{j}^{( n , t )} log {ψ}_{g} ( {f}_{τ}^{( n )} , i , j ) - \\ {\frac{- {D}_{{α}_{i}}}{2} log {\sum }_{n = 1}^{N} {\sum }_{j ∈ {𝒢}_{i}} {q}_{j}^{( n , t )}}_{}\end{matrix} & & & ( Equation 18 ) \\ {ϕ}_{j}^{( t )} = & \begin{matrix}{argmax}_{{α}_{i}} {\sum }_{n = 1}^{N} {q}_{j}^{( n , t )} log p ( {τ}^{( n )} \vert {f}_{τ}^{( n )} , {ϕ}_{j} ) - \\ {\frac{1}{2} {\sum }_{k = 1}^{{D}_{{ϕ}_{j}}} log \{ {l}_{jk} {\sum }_{n = 1}^{N} {q}_{j}^{( n , t )} \}}_{}\end{matrix} & & & ( Equation 19 )\end{matrix}$$

On the other hand, as described above, there is a possibility that the factorized information criterion does not monotonically increase due to the influence of approximation by importance sampling. Therefore, the learning unit 30 first learns the model based on the EM algorithm, and once the monotonically increasing nature of the log-likelihood is confirmed, it considers that the accuracy of the approximation by importance sampling has improved and switch the learning method to FAB inference. In other words, the learning unit 30 determines monotonically increasing nature of the log-likelihood as a predetermined condition.

The learning unit 30 includes a first learning unit 31 and a second learning unit 32.

The first learning unit 31 learns a model using the EM algorithm for the HME and calculates the log-likelihood. Specifically, the first learning unit 31 updates the parameter θ based on the input decision-making history, and learns to maximize the log-likelihood of the decision-making history.

Here, the wavy underlined part in Equation 17 above is an equation representing the regularization effect of FAB inference, and the equations excluding this term match the update equation in the E-step of the normal EM algorithm for HME. Therefore, the first learning unit 31 may learn the model by the EM algorithm using the equation obtained by excluding the equation representing the regularization effect of FAB inference from the equation used when updating the variational probability of the hidden variable used in FAB inference.

Similarly, except for the broken line part in Equations 18 and 19 above, the excluded equation matches the update equation in the M-step of the normal algorithm for HME. The first learning unit 31 may learn the model by the EM algorithm based on this update equation. The learning method using the EM algorithm for HME is widely known, and the specific explanation is omitted here.

The second learning unit 32 determines whether or not the log-likelihood is monotonically increasing during the learning performed by the first learning unit 31. If it determines that the log-likelihood is monotonically increasing, the second learning unit 32 switches the learning method from the EM algorithm to FAB inference, and learns by the FAB inference.

Specifically, when the second learning unit 32 determines that the log-likelihood is monotonically increasing, it updates the variational probability of the hidden variable using Equation 17 above to maximize the factorized information criterion, and the second learning unit 32 updates the parameters of the model (branching conditions and parameters of the reward function) using Equations 18 and 19 above. The second learning unit 32 may perform the FAB inference by the method described in non-patent literature 1, for example.

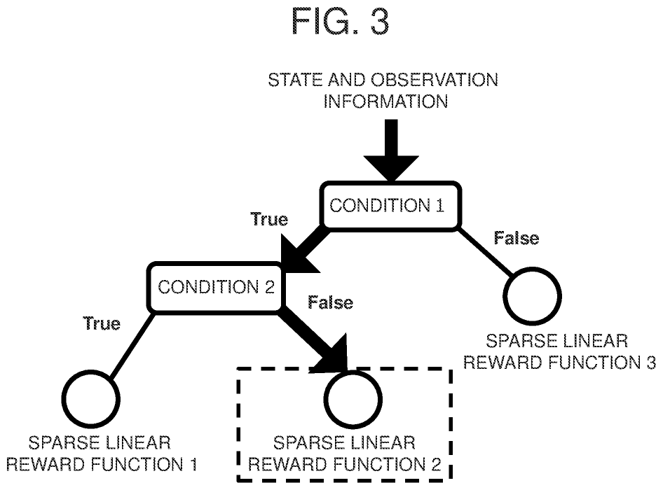

The output unit 40 outputs the learned hierarchical mixtures of experts. Specifically, the output unit 40 outputs a model that maximizes the factorized information criterion (HME model). FIG. 3 is an explanatory diagram showing an example of hierarchical mixtures of experts. The HME model illustrated in FIG. 3 is a model in which one reward function is selected according to state and observation information. The example shown in FIG. 3 indicates that the sparse linear reward function 2 is selected when the input state and observation information satisfy condition 1 and does not satisfy condition 2.

The input unit 20, the learning unit 30 (more specifically, the first learning unit 31 and the second learning unit 32), and the output unit 40 are realized by a processor (for example, CPU (Central Processing Unit), GPU (Graphics Processing Unit)) of a computer that operates according to a program (a learning program).

For example, a program may be stored in the storage unit 10 of the learning device 100, and the processor may read the program and operate as the input unit 20, the learning unit 30 (more specifically, the first learning unit 31 and the second learning unit 32), and the output unit 40 according to the program. In addition, the functions of the learning device 100 may be provided in the form of SaaS (Software as a Service).

The input unit 20, the learning unit 30 (more specifically, the first learning unit 31 and the second learning unit 32), and the output unit 40 may each be realized by dedicated hardware. Some or all of the components of each device may be realized by general-purpose or dedicated circuit, a processor, or combinations thereof. These may be configured by a single chip or by multiple chips connected through a bus. Some or all of the components of each device may be realized by a combination of the above-mentioned circuit, etc., and a program.

When some or all of the components of the learning device 100 are realized by multiple information processing devices, circuits, etc., the multiple information processing devices, circuits, etc. may be centrally located or distributed. For example, the information processing devices, circuits, etc. may be realized as a client-server system, a cloud computing system, etc., each of which is connected through a communication network.

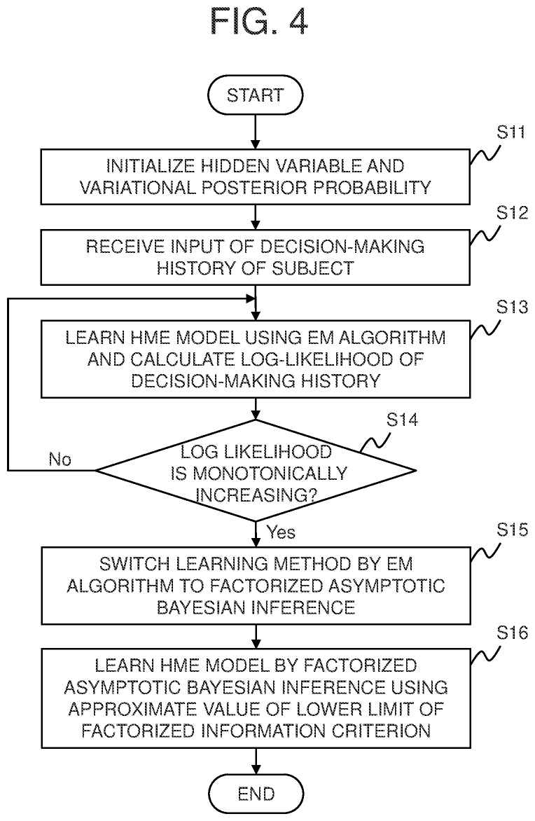

Next, the operation of the learning device 100 of this exemplary embodiment will be described. FIG. 4 is an explanatory diagram showing an operation example of the learning device 100. The learning unit 30 initializes a hidden variable and a variational posterior probability (step S11). The input unit 20 receives input of a decision-making history of a subject (step S12). The learning unit 30 (the first learning unit 31) learns a HME model using an EM algorithm and calculates the log-likelihood of the decision-making history (step S13). The learning unit 30 (the second learning unit 32) determines whether or not the log likelihood is monotonically increasing (step S14). If it is determined that the log-likelihood is not monotonically increasing (No in step S14), the processing of step S13 is repeated.

On the other hand, if it is determined that the log-likelihood is monotonically increasing (Yes in step S14), the learning unit 30 (the second learning unit 32) switches a learning method using the EM algorithm to factorized asymptotic Bayesian inference (step S15). Then, the learning unit 30 (the second learning unit 32) learns the HME model by the switched factorized asymptotic Bayesian inference using an approximate value of the lower limit of a factorized information criterion (step S16).

As described above, in this exemplary embodiment, the input unit 20 receives input of a decision-making history of a subject, the learning unit 30 learns a HME model by inverse reinforcement learning based on the decision-making history, and the output unit 40 outputs the learned HME model, and the output unit 40 outputs the learned HME model. Then, when the above learning, the learning unit 30 learns the HME model using an EM algorithm, and when a learning result using the EM algorithm satisfies a predetermined condition, learns the HME model by factorized asymptotic Bayesian inference. More specifically, the first learning unit 31 learns the HME model using the EM algorithm and calculates a log likelihood of the decision-making history, and when the first learning unit 31 determines that the log likelihood is monotonically increasing, the second learning unit 32 switches a learning method using the EM algorithm to the factorized asymptotic Bayesian inference, and learns the HME model by the factorized asymptotic Bayesian inference using an approximate value of the lower limit of a factorized information criterion.

Therefore, it is possible to improve an estimation accuracy of the model when learning hierarchical mixtures of experts by inverse reinforcement learning.

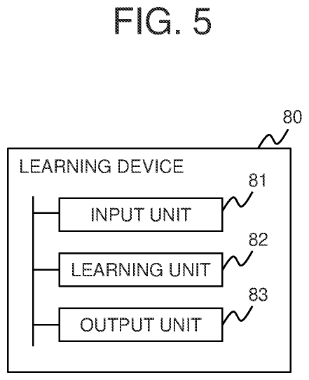

Next, an overview of the present invention will be explained. FIG. 5 is a block diagram showing a summarized learning device according to the present invention. The learning device 80 according to the present invention comprises an input unit 81 (for example, the input unit 20) which receives input of a decision-making history of a subject, a learning unit 82 (for example, the learning unit 30) which learns hierarchical mixtures of experts by inverse reinforcement learning based on the decision-making history, and an output unit 83 (for example, the output unit 40) which outputs the learned hierarchical mixtures of experts.

The learning unit 82 learns the hierarchical mixtures of experts using an EM algorithm, and when a learning result using the EM algorithm satisfies a predetermined condition, learns the hierarchical mixtures of experts by factorized asymptotic Bayesian inference.

By such a configuration, it is possible to improve an estimation accuracy of the model when learning hierarchical mixtures of experts by inverse reinforcement learning.

Specifically, the learning unit 82 may include a first learning unit (for example, the first learning unit 31) which learns the hierarchical mixtures of experts using the EM algorithm and calculates a log likelihood of the decision-making history, and when it is determined that the log likelihood is monotonically increasing, a second learning unit (for example, the second learning unit 32) which switches a learning method using the EM algorithm to the factorized asymptotic Bayesian inference, and learns the hierarchical mixtures of experts by the factorized asymptotic Bayesian inference using an approximate value of the lower limit of a factorized information criterion.

Then, the first learning unit may repeat learning the hierarchical mixtures of experts by the EM algorithm until it is determined that the log likelihood is monotonically increasing.

In addition, the first learning unit may learn a model by the EM algorithm using an equation excluding terms (for example, wavy underlined parts in Equations 17-19 shown above) that represents regularization effect of the factorized asymptotic Bayesian inference from equations (for example, Equations 17 to 19 shown above) used when updating the variational probabilities of hidden variables used in the factorized asymptotic Bayesian inference.

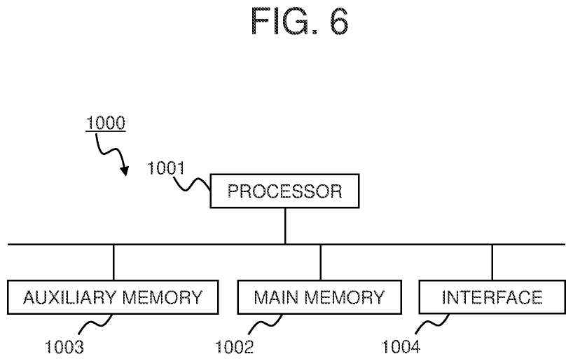

FIG. 6 is a summarized block diagram showing a configuration of a computer for at least one exemplary embodiment. The computer 1000 comprises a processor 1001, a main memory 1002, an auxiliary memory 1003, and an interface 1004.

The learning device 80 described above are implemented in the computer 1000. The operation of each of the above mentioned processing units is stored in the auxiliary memory 1003 in a form of a program (learning program). The processor 1001 reads the program from the auxiliary memory 1003, deploys the program to the main memory 1002, and implements the above described processing in accordance with the program.

In at least one exemplary embodiment, the auxiliary memory 1003 is an example of a non-transitory tangible medium. Other examples of non-transitory tangible media include a magnetic disk, an optical magnetic disk, a CD-ROM (Compact Disc Read only memory), a DVD-ROM (Read-only memory), a semiconductor memory, and the like. When the program is transmitted to the computer 1000 through a communication line, the computer 1000 receiving the transmission may deploy the program to the main memory 1002 and perform the above process.

The program may also be one for realizing some of the aforementioned functions. Furthermore, said program may be a so-called differential file (differential program), which realizes the aforementioned functions in combination with other programs already stored in the auxiliary memory 1003.

### REFERENCE SIGNS LIST

10 Storage unit
20 Input unit
30 Learning unit
31 First learning unit
32 Second learning unit
40 Output unit

What is claimed is:

1. A learning device comprising:
a memory storing instructions; and
one or more processors configured to execute the instructions to:
receive input of a decision-making history of a subject;
learn hierarchical mixtures of experts by inverse reinforcement learning based on the decision-making history;
output the learned hierarchical mixtures of experts; and
learn the hierarchical mixtures of experts using an EM algorithm, and when a learning result using the EM algorithm satisfies a predetermined condition, learn the hierarchical mixtures of experts by factorized asymptotic Bayesian inference.

2. The learning device according to claim 1, wherein the processor further executes instructions to:
learn the hierarchical mixtures of experts using the EM algorithm and calculate a log likelihood of the decision-making history; and
when it is determined that the log likelihood is monotonically increasing, a second learning unit which switch a learning method using the EM algorithm to the factorized asymptotic Bayesian inference, and learn the hierarchical mixtures of experts by the factorized asymptotic Bayesian inference using an approximate value of the lower limit of a factorized information criterion.

3. The learning device according to claim 2, wherein the processor further executes instructions to
repeat learning the hierarchical mixtures of experts by the EM algorithm until it is determined that the log likelihood is monotonically increasing.

4. The learning device according to claim 2, wherein the processor further executes instructions to
learn a model by the EM algorithm using an equation excluding terms that represents regularization effect of the factorized asymptotic Bayesian inference from equations used when updating the variational probabilities of hidden variables used in the factorized asymptotic Bayesian inference.

5. A learning method comprising:
receiving input of a decision-making history of a subject;
learning hierarchical mixtures of experts by inverse reinforcement learning based on the decision-making history;
outputting the learned hierarchical mixtures of experts; and
when the learning,
learning the hierarchical mixtures of experts using an EM algorithm, and when a learning result using the EM algorithm satisfies a predetermined condition, learning the hierarchical mixtures of experts by factorized asymptotic Bayesian inference.

6. The learning method according to claim 5, further comprising:
learning the hierarchical mixtures of experts using the EM algorithm and calculating a log likelihood of the decision-making history; and
when it is determined that the log likelihood is monotonically increasing, switching a learning method using the EM algorithm to the factorized asymptotic Bayesian inference, and learning the hierarchical mixtures of experts by the factorized asymptotic Bayesian inference using an approximate value of the lower limit of a factorized information criterion.

7. A non-transitory computer readable information recording medium storing a learning program, when executed by a processor, that performs a method for:
receiving input of a decision-making history of a subject;
learning hierarchical mixtures of experts by inverse reinforcement learning based on the decision-making history;
outputting the learned hierarchical mixtures of experts; and
when the learning, learning the hierarchical mixtures of experts using an EM algorithm, and when a learning result using the EM algorithm satisfies a predetermined condition, learning the hierarchical mixtures of experts by factorized asymptotic Bayesian inference.

8. The non-transitory computer readable information recording medium according to claim 7, further comprising:
learning the hierarchical mixtures of experts using the EM algorithm and calculating a log likelihood of the decision-making history; and
when it is determined that the log likelihood is monotonically increasing, switching a learning method using the EM algorithm to the factorized asymptotic Bayesian inference, and learning the hierarchical mixtures of experts by the factorized asymptotic Bayesian inference using an approximate value of the lower limit of a factorized information criterion.
